(19) United States
(12) Patent Application Publication
(10) Pub. No.: US 2021/0352401 A1
(43) Pub. Date: Nov. 11, 2021

(54) SOUND-RECEIVING DEVICE

(71) Applicant: LUXSHARE-ICT CO., LTD., Taipei City (TW)

(72) Inventors: Kuan-Chun LIAO, Taipei City (TW); You-Yu LIN, Taipei City (TW); Hui-Yu WANG, Taipei City (TW); Shao-Hsiang CHEN, Taipei City (TW)

(73) Assignee: LUXSHARE-ICT CO., LTD., Taipei City (TW)

(21) Appl. No.: 17/385,248

(22) Filed: Jul. 26, 2021

(30) Foreign Application Priority Data
Jun. 2, 2021 (TW) 110120077

(51) Int. Cl. H04R 1/34; H04R 1/02

(52) U.S. Cl. CPC H04R 1/342; H04R 1/02

(57) ABSTRACT

A sound-receiving device includes a housing, a connecting cavity, a sound-receiving assembly, and a signal processing circuit. An outer surface of the housing is provided with a first sound-receiving hole and a second sound-receiving hole. The connecting cavity is provided in an internal space of the housing. The connecting cavity includes a connecting channel. A first hole and a second hole are respectively provided at two ends of the connecting channel. The first hole is connected to the first sound-receiving hole, and the second hole is connected to the second sound-receiving hole. The sound-receiving assembly includes a first sound-receiving diaphragm and a second sound-receiving diaphragm. The sound-receiving assembly is disposed between the first hole and the first sound-receiving hole. The signal processing circuit is electrically connected to the sound-receiving assembly. The signal processing circuit generates an output result according to the first sound and the second sound.

### CROSS-REFERENCE TO RELATED APPLICATION

This non-provisional application claims priority under 35 U.S.C. § 119(a) to Patent Application No. 110120077 filed in Taiwan, R.O.C. on Jun. 2, 2021, the entire contents of which are hereby incorporated by reference.

### BACKGROUND

### Technical Field

The present invention relates to a sound processing device, and in particular, to a sound-receiving device.

### Related Art

With the rapid growth of the Internet, online conferences are increasingly popular. Generally, call quality of an online conference depends on a sound-receiving device, for example, an omni-directional microphone or directional microphone. The omni-directional microphone can receive and record sounds around the microphone. However, because all the sounds are received and recorded, in addition to sounds of a target, other background noise is also received and recorded. Although other manufacturers provide recording software with a noise reduction function, a reinforcing effect of the software is really limited. In addition, if sounds are received and recorded by using an array microphone, although better recording quality can be achieved, the array microphone has a huge volume and excessively high setup costs.

### SUMMARY

In view of this, in some embodiments, a sound-receiving device includes a housing, a connecting cavity, a sound-receiving assembly, and a signal processing circuit. An outer surface of the housing is provided with a first sound-receiving hole and a second sound-receiving hole. The connecting cavity is provided in an internal space of the housing. The connecting cavity includes a connecting channel. A first hole and a second hole are respectively provided at two ends of the connecting channel. The first hole is connected to the first sound-receiving hole, and the second hole is connected to the second sound-receiving hole. The sound-receiving assembly includes a first sound-receiving diaphragm and a second sound-receiving diaphragm. The sound-receiving assembly is disposed between the first hole and the first sound-receiving hole. The first sound-receiving diaphragm receives a first sound, and the second sound-receiving diaphragm receives a second sound. The signal processing circuit is electrically connected to the sound-receiving assembly. The signal processing circuit generates an output result according to the first sound and the second sound. Disposition positions of the first sound-receiving diaphragm and the second sound-receiving diaphragm are adjusted by the sound-receiving device, so that received sounds form a phase difference, to achieve directional sound receiving.

In some embodiments, the outer surface includes a first surface and a second surface, the first hole is provided on the first surface, and the second hole is provided on the second surface.

In some embodiments, an angle between the first surface and the second surface ranges from 90 degrees to 180 degrees.

In some embodiments, the first sound-receiving diaphragm and the second sound-receiving diaphragm are two opposite side surfaces.

In some embodiments, the sound-receiving assembly separates the connecting channel. A first sound-receiving channel is formed between the first sound-receiving diaphragm and the first sound-receiving hole, and a second sound-receiving channel is formed between the second sound-receiving diaphragm and the second sound-receiving hole. A distance of the first sound-receiving channel is less than or equal to a distance of the second sound-receiving channel.

In some embodiments, the signal processing circuit adjusts the first sound according to a phase relationship between the first sound and the second sound, to generate the output result.

In some embodiments, the sound-receiving device includes a first outer cover and a second outer cover. The first outer cover is disposed at the first sound-receiving hole, the second outer cover is disposed at the second sound-receiving hole. The first outer cover and the second outer cover have a mesh cover density relationship. The sound-receiving assembly adjusts the first sound according to the phase relationship and the mesh cover density relationship, to generate the output result.

In some embodiments, the sound-receiving device includes a first fixing member. The first fixing member is disposed at the first sound-receiving hole and is located in the internal space.

In some embodiments, the sound-receiving device includes a second fixing member. The second fixing member is disposed at the first hole. A fixing structure is formed between the first fixing member and the second fixing member. The sound-receiving assembly is accommodated in the fixing structure.

In some embodiments, the sound-receiving device includes a buffer member. The buffer member is disposed between the sound-receiving assembly and the fixing structure, and the sound-receiving assembly is fixed into the fixing structure by using the buffer member.

The sound-receiving device is configured to control a range of directional sound receiving by adjusting positions of the first sound-receiving diaphragm and the second sound-receiving diaphragm and distances of a first channel and a second channel. The sound-receiving device may be equipped with an outer mesh cover, to further adjust the range of directional sound receiving. The sound-receiving device can control sound receiving in a specific region by using the foregoing various sound-receiving structures, to not only reduce a load of software processing, but also prevent an increase in additional hardware costs.

### BRIEF DESCRIPTION OF THE DRAWINGS

FIG. 1 is a schematic outside view of a sound-receiving device according to an embodiment;

FIG. 2 is a schematic diagram of a hardware architecture of a sound-receiving device according to an embodiment;

FIG. 3 is a cross-sectional view of a sound-receiving device according to an embodiment;

FIG. 4 is another cross-sectional view of a sound-receiving device according to an embodiment;

FIG. 5A is a schematic outside view of a first outer cover and a second outer cover according to an embodiment;

FIG. 5B is a schematic outside view of a first outer cover and another second outer cover according to an embodiment;

FIG. 6 is a cross-sectional view of a sound-receiving device including a first outer cover and a second outer cover according to an embodiment;

FIG. 7 is a cross-sectional view of a sound-receiving device including an accommodation structure according to an embodiment;

FIG. 8A is a cross-sectional view of a sound-receiving device including a buffer member according to an embodiment;

FIG. 8B is a cross-sectional view of a sound-receiving device including another buffer member according to an embodiment;

FIG. 9A is a polar pattern diagram of sound receiving according to an embodiment;

FIG. 9B is a polar pattern diagram of sound receiving according to an embodiment when an outer cover is included;

FIG. 9C is a polar pattern diagram of sound receiving according to an embodiment; and

FIG. 9D is a polar pattern diagram of sound receiving according to an embodiment when an outer cover is included.

### DETAILED DESCRIPTION

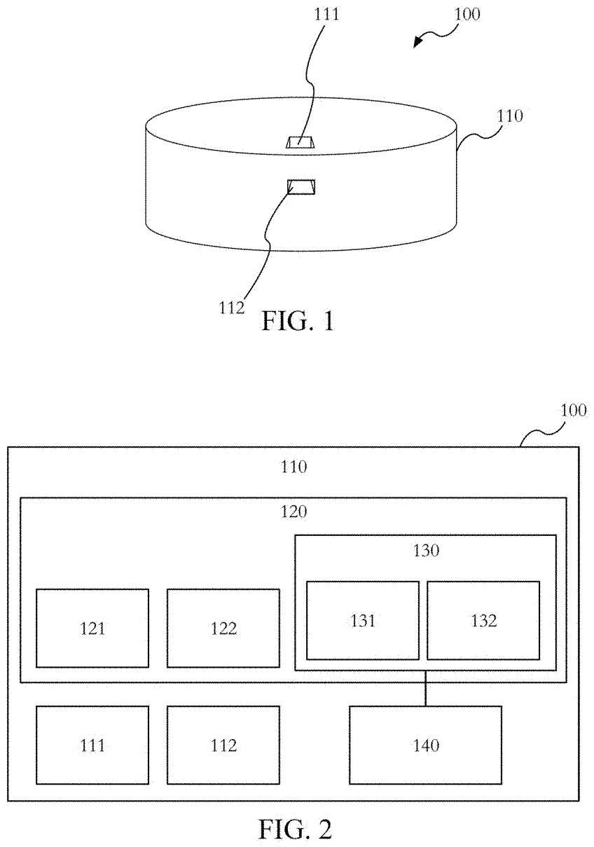

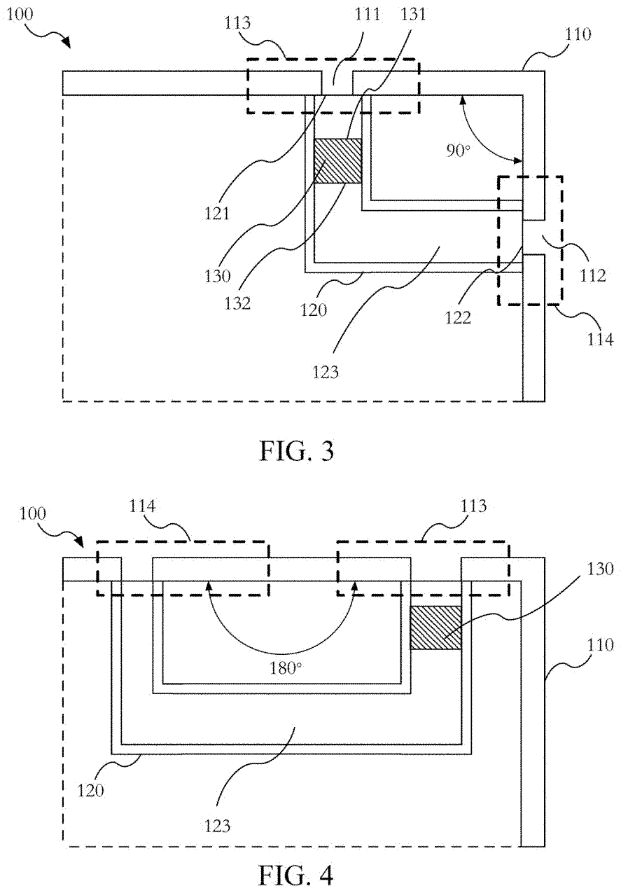

FIG. 1, FIG. 2, and FIG. 3 are respectively a schematic outside view, a schematic diagram of a hardware architecture, and a cross-sectional view of a sound-receiving device 100 according to an embodiment. As shown in FIG. 1, the sound-receiving device 100 includes a housing 110, a connecting cavity 120, a sound-receiving assembly 130, and a signal processing circuit 140. A shape of the housing 110 may be, but is not limited to, a cylinder, or may be a cube or a sphere. In FIG. 1, a cylinder is used for description.

The housing 110 includes an outer surface (not numbered) and an internal space (not numbered). The outer surface is provided with a first sound-receiving hole 111 and a second sound-receiving hole 112. The connecting cavity 120 is provided in the internal space of the housing 110, as shown by a region formed by a dashed line and the outer surface in FIG. 3. The internal space does not need to be filled with a solid material, and may alternatively be a hollow region. The connecting cavity 120 includes a first hole 121, a second hole 122, and a connecting channel 123, and the first hole 121 and the second hole 122 are respectively provided at two ends of the connecting channel 123. Referring to FIG. 3, the first hole 121 is connected to the first sound-receiving hole 111, and the second hole 122 is connected to the second sound-receiving hole 112. A hole diameter of the first hole 121 does not need to be the same as a hole diameter of the first sound-receiving hole 111. For example, in FIG. 3, the hole diameter of the first sound-receiving hole 111 is less than the hole diameter of the first hole 121. Similarly, a hole diameter of the second hole 122 does not need to be equal to a hole diameter of the second sound-receiving hole 112. A structure of the connecting channel 123 is determined according to positions of the first sound-receiving hole 111 and the second sound-receiving hole 112 (which is additionally described below).

The sound-receiving assembly 130 includes a first sound-receiving diaphragm 131 and a second sound-receiving diaphragm 132. The sound-receiving assembly 130 is disposed inside the connecting channel 123. The sound-receiving assembly 130 is configured to receive sound, and convert a sound signal into an electrical signal. The sound-receiving assembly 130 is electrically connected to the signal processing circuit 140. The signal processing circuit 140 generates an output result according to the electrical signal. A cross-sectional area of the sound-receiving assembly 130 is equal to a cross-sectional area of the connecting channel 123. The sound-receiving assembly 130 separates the connecting channel 123 into two separate regions (functions of the two separate regions are additionally described below). The first sound-receiving diaphragm 131 and the second sound-receiving diaphragm 132 are respectively disposed on two opposite side surfaces of the sound-receiving assembly 130. The first sound-receiving diaphragm 131 and the second sound-receiving diaphragm 132 respectively receive two sounds from a same sound source. The first sound-receiving diaphragm 131 receives a first sound from the sound source, and the second sound-receiving diaphragm 132 receives a second sound from the sound source. In other words, the first sound-receiving diaphragm 131 is configured to receive the sound from the first sound-receiving hole 111. The second sound-receiving diaphragm 132 is configured to receive the sound from the second sound-receiving hole 112.

In an embodiment, the outer surface includes a first surface 113 and a second surface 114. The first hole 121 is provided on the first surface 113, and the second hole 122 is provided on the second surface 114. In FIG. 3, portions of the housing 110 that are circled by dashed-line boxes are the first surface 113 and the second surface 114. An angle between the first surface 113 and the second surface 114 ranges from 90 degrees to 180 degrees. The angle of the surfaces is an angle included by a joint of the first surface 113 and the second surface 114 located in the internal space. As shown in FIG. 3, the angle between the first surface 113 and the second surface 114 is 90 degrees. The connecting channel 123 forms an “L”-shaped hollow structure, and two ends of the connecting channel 123 respectively correspond to positions of the first hole 121 and the second hole 122.

As shown in FIG. 4, in an embodiment, the angle between the first surface 113 and the second surface 114 is 180 degrees. FIG. 4 is a schematic cross-sectional view of a sound-receiving device 100 according to an embodiment. A “u”-shaped connecting channel 123 is formed inside the connecting cavity 120. Alternatively, a “U”-shaped connecting channel 123 may be formed inside the connecting cavity 120. In addition, two ends of the connecting channel 123 respectively correspond to the positions of the first hole 121 and the second hole 122. The sound-receiving assembly 130 is disposed inside the connecting channel 123. The cross-sectional area of the sound-receiving assembly 130 is equal to the cross-sectional area of the connecting channel 123, so that two sound-receiving diaphragms of the sound-receiving assembly 130 can respectively receive sounds from the first sound-receiving hole 111 and the second sound-receiving hole 112 without interfering with each other. In other words, the first sound-receiving diaphragm 131 receives a sound from the first sound-receiving hole 111; and the second sound-receiving diaphragm 132 receives a sound from the second sound-receiving hole 112.

In an embodiment, a space between the first sound-receiving diaphragm 131 and the first sound-receiving hole 111 is a first channel. A space between the second sound-receiving diaphragm 132 and the second sound-receiving hole 112 is a second channel. Referring to FIG. 3 and FIG. 4, a distance of the first channel is less than a distance of the second channel. The first sound and the second sound are in a phase relationship. The phase relationship is a phase deviation caused by two time points at which the sound-receiving assembly 130 receives the first sound and the second sound. Alternatively, as shown in FIG. 4, the cross-sectional area of the first channel may be different from the cross-sectional area of the second channel.

The sound-receiving assembly 130 receives the first sound and the second sound in a time division manner. The signal processing circuit 140 adjusts the phase relationship between the first sound and the second sound according to a distance difference between the first channel and the second channel. The signal processing circuit 140 is configured to offset a phase of the first sound according to a phase of the second sound, to reduce interference other than voice in the first sound.

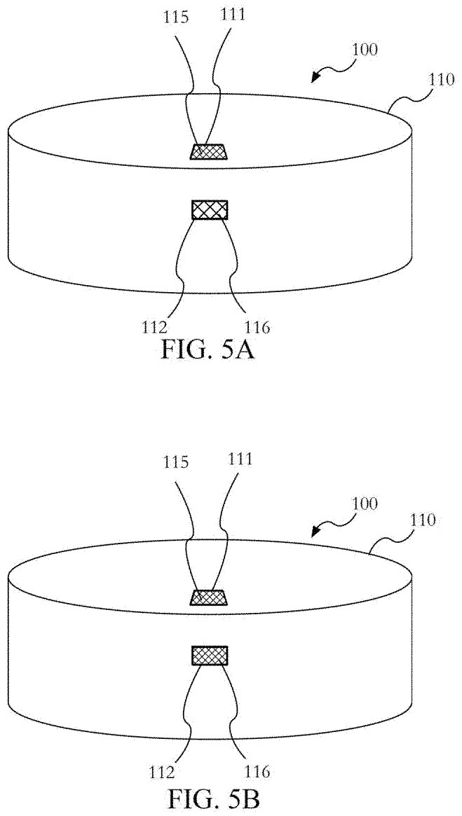

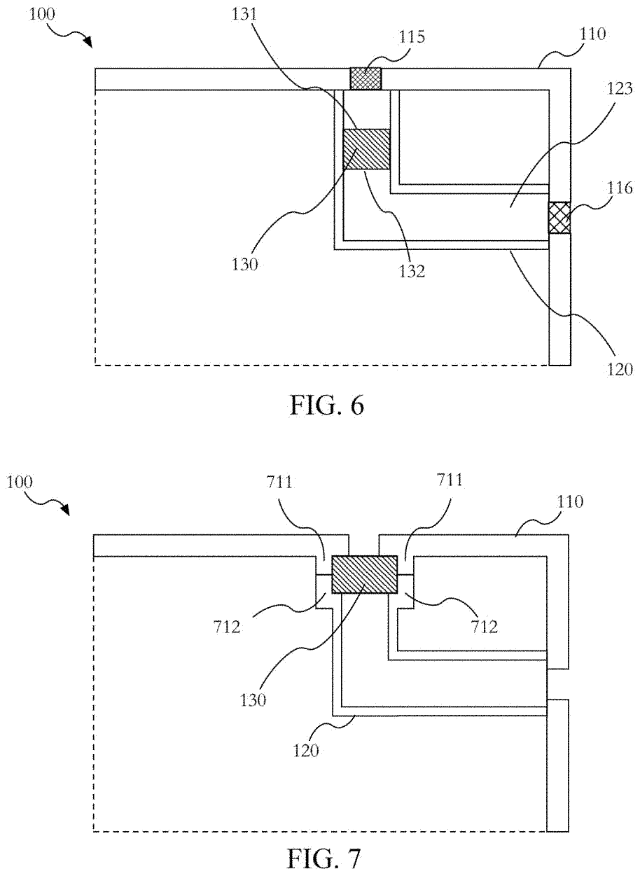

In an embodiment, the sound-receiving device 100 includes a first outer cover 115 and a second outer cover 116. Referring to FIG. 5A, FIG. 5B, and FIG. 6, the first outer cover 115 is disposed on the first sound-receiving hole 111, and the second outer cover 116 is disposed on the second sound-receiving hole 112. FIG. 5A and FIG. 5B are respectively schematic outside views of the sound-receiving device 100 and different mesh covers, and FIG. 6 is a cross-sectional view of the sound-receiving device 100. The first outer cover 115 and the second outer cover 116 may be configured to filter jet noise during sound receiving and reduce sound intensity. The first outer cover 115 has a first mesh cover density, and the second outer cover 116 has a second mesh cover density. Intensity of a received sound is affected by the mesh cover density. As shown in FIG. 5A and FIG. 5B, the first mesh cover density does not need to be equal to the second mesh cover density. However, the first mesh cover density and the second mesh cover density form a mesh cover density relationship. The mesh cover density relationship is used for indicating a density ratio of the first mesh cover density to the second mesh cover density. Attributes, such as the intensity and the phase, of the first sound and the second sound are adjusted according to different mesh cover density relationships.

The signal processing circuit 140 adjusts the first sound and the second sound according to the phase relationship and the mesh cover density relationship, and generates an output result. The output result is an electrical signal or a digital signal of the adjusted first sound. The signal processing circuit 140 provides the output result to a computer apparatus or a recording device connected to the sound-receiving device 100.

Referring to FIG. 7, in an embodiment, the sound-receiving device 100 includes a first fixing member 711 and a second fixing member 712. FIG. 7 is a schematic cross-sectional view of a sound-receiving device 100 according to an embodiment. The first fixing member 711 is disposed at a position that is located in an internal space of the housing 110 and that corresponds to the first sound-receiving hole 111. Moreover, the first fixing member 711 may be disposed along an edge or a periphery of the first sound-receiving hole 111. FIG. 7 shows that the first fixing member 711 is disposed along the periphery of the first sound-receiving hole 111. The second fixing member 712 is disposed on an outer edge of the first hole 121. A position and a size of the second fixing member 712 correspond to a position and a size of the first fixing member 711. The first fixing member 711 may be connected to the second fixing member 712, and a hollow space is formed between the first fixing member 711 and the second fixing member 712. The hollow space is referred to as a fixing structure (not numbered). The sound-receiving assembly 130 is accommodated in the fixing structure.

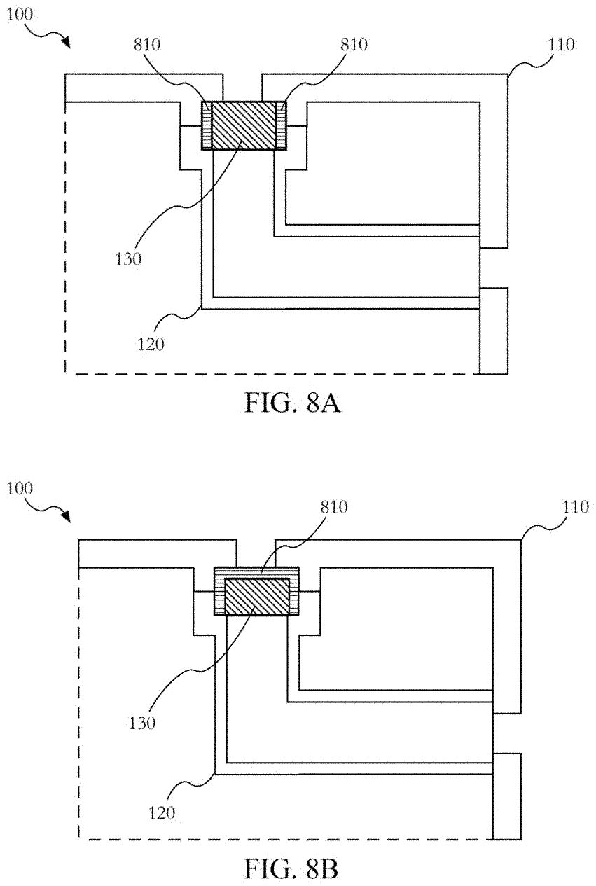

Referring to FIG. 8A, in an embodiment, the sound-receiving device 100 includes a first fixing member 711, a second fixing member 712, and a buffer member 810. The buffer member 810 is disposed between the sound-receiving assembly 130 and the fixing structure. Referring to FIG. 8A, the buffer member 810 covers at least a side wall of the sound-receiving assembly 130. The side wall is a wall between the first sound-receiving diaphragm 131 and the second sound-receiving diaphragm 132. Further, as shown in FIG. 8B, the buffer member 810 may partially cover the first sound-receiving diaphragm 131 or the second sound-receiving diaphragm 132. In addition to fixing the sound-receiving assembly 130 into the fixing structure, the buffer member 810 is configured to prevent noise from being generated during collision between the sound-receiving assembly 130 and the fixing structure. A material of the buffer member 810 may be sponge, rubber, or a soft material.

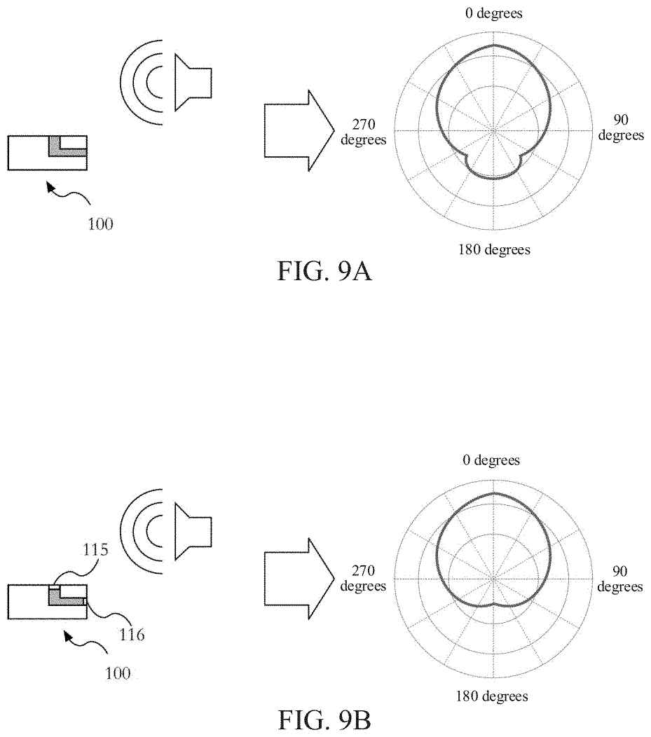

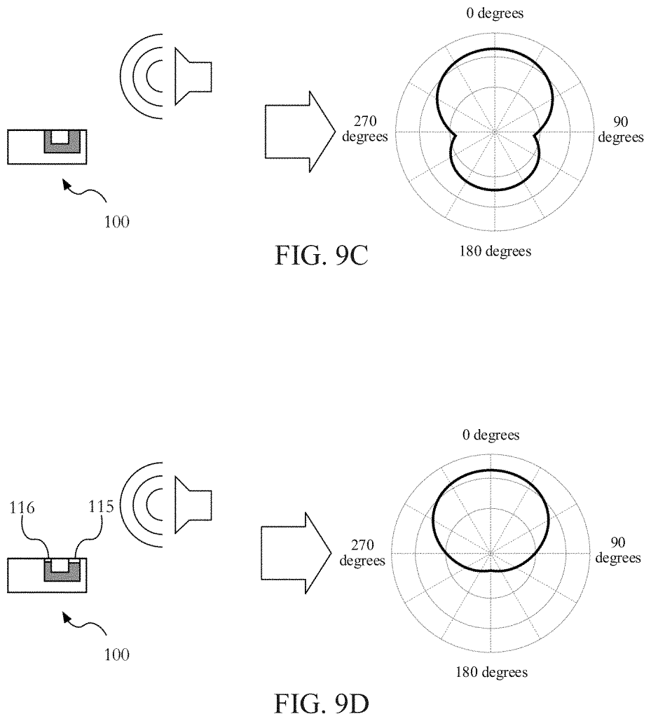

FIG. 9A to FIG. 9D are respectively schematic polar pattern diagrams of different embodiments. FIG. 9A corresponds to the sound-receiving device 100 of FIG. 2 and FIG. 3. In FIG. 9A, the first sound-receiving hole 111 is taken as a center position of a polar pattern diagram of sound receiving. FIG. 9A shows a sound-receiving device 100 (the left side of FIG. 9A) of which a first surface 113 and a second surface 114 form an angle of 90 degrees, and the sound source is disposed above the first sound-receiving hole 111. The connecting cavity 120 is represented by a gray block. When the sound source emits sounds to the sound-receiving device 100, the sound-receiving assembly 130 receives a first sound and a second sound. As shown in the right side of FIG. 9A, the signal processing circuit 140 outputs a corresponding output result for the first sound according to the second sound.

FIG. 9B is a polar pattern diagram of sound receiving of the sound-receiving device 100 in FIG. 9A having an outer cover added outside the first sound-receiving hole 111 and the second sound-receiving hole 112. FIG. 9C shows a sound-receiving device 100 (left side of FIG. 9C) of which a first surface 113 and a second surface 114 form an angle 180 degrees. The connecting cavity 120 in FIG. 9C is represented by a gray block. FIG. 9D is a polar pattern diagram of sound receiving of the sound-receiving device 100 in FIG. 9C equipped with a first outer cover 115 and a second outer cover 116.

The sound-receiving device 100 is configured to control a range of directional sound receiving by adjusting positions of the first sound-receiving diaphragm 131 and the second sound-receiving diaphragm 132 and distances of the first channel and the second channel. The sound-receiving device 100 may be equipped with an outer mesh cover, to further adjust the range of directional sound receiving. The sound-receiving device 100 can control sound receiving in a specific region by using the foregoing various sound-receiving structures, to not only reduce a load of software processing, but also prevent an increase in additional hardware costs.

What is claimed is:

1. A sound-receiving device, comprising:
a housing, wherein an outer surface of the housing is provided with a first sound-receiving hole and a second sound-receiving hole;
a connecting cavity, provided in an internal space of the housing, wherein the connecting cavity comprises a connecting channel, a first hole and a second hole are respectively provided at two ends of the connecting channel, the first hole is connected to the first sound-receiving hole, and the second hole is connected to the second sound-receiving hole;
a sound-receiving assembly, comprising a first sound-receiving diaphragm and a second sound-receiving diaphragm, wherein the sound-receiving assembly is disposed between the first hole and the first sound-receiving hole, the first sound-receiving diaphragm receives a first sound, and the second sound-receiving diaphragm receives a second sound; and
a signal processing circuit, electrically connected to the sound-receiving assembly, wherein the signal processing circuit generates an output result according to the first sound and the second sound.

2. The sound-receiving device according to claim 1, wherein the outer surface comprises a first surface and a second surface, the first hole is provided on the first surface, and the second hole is provided on the second surface.

3. The sound-receiving device according to claim 2, wherein an angle between the first surface and the second surface ranges from 90 degrees to 180 degrees.

4. The sound-receiving device according to claim 1, wherein the first sound-receiving diaphragm and the second sound-receiving diaphragm are two opposite side surfaces.

5. The sound-receiving device according to claim 4, wherein the sound-receiving assembly separates the connecting channel, a first sound-receiving channel is formed between the first sound-receiving diaphragm and the first sound-receiving hole, and a second sound-receiving channel is formed between the second sound-receiving diaphragm and the second sound-receiving hole, wherein a distance of the first sound-receiving channel is less than or equal to a distance of the second sound-receiving channel.

6. The sound-receiving device according to claim 5, wherein the signal processing circuit adjusts the first sound according to a phase relationship between the first sound and the second sound, to generate the output result.

7. The sound-receiving device according to claim 6, comprising a first outer cover and a second outer cover, wherein the first outer cover is disposed on the first sound-receiving hole, the second outer cover is disposed on the second sound-receiving hole, the first outer cover and the second outer cover have a mesh cover density relationship, and the sound-receiving assembly adjusts the first sound according to the phase relationship and the mesh cover density relationship, to generate the output result.

8. The sound-receiving device according to claim 1, wherein the sound-receiving device comprises a first fixing member and a second fixing member, the first fixing member is disposed at the first sound-receiving hole and is located in the internal space, and the second fixing member is disposed at the second sound-receiving hole and is located in the internal space.

9. The sound-receiving device according to claim 8, wherein the second fixing member is disposed at the first hole, a fixing structure is formed between the first fixing member and the second fixing member, and the sound-receiving assembly is accommodated in the fixing structure.

10. The sound-receiving device according to claim 9, comprising a buffer member, disposed between the sound-receiving assembly and the fixing structure, wherein the sound-receiving assembly is fixed into the fixing structure by using the buffer member.
